(19) United States
(12) Patent Application Publication
(10) Pub. No.: US 2020/0225992 A1
(43) Pub. Date: Jul. 16, 2020

(54) OPERATING METHOD OF OPERATING SYSTEM AND ELECTRONIC DEVICE SUPPORTING SAME

(71) Applicant: Samsung Electronics Co., Ltd., Suwon-si, Gyeonggi-do (KR)

(72) Inventors: Kyung Seok LEE, Hwaseong-si (KR); Hyun Joon KIM, Suwon-si (KR); Byung Soo KWON, Yongin-si (KR); Hak Ryoul KIM, Suwon-si (KR); Hyo Jong KIM, Suwon-si (KR); Won Seo CHOI, Yongin-si (KR)

(21) Appl. No.: 16/641,177

(22) PCT Filed: Jul. 19, 2018
(86) PCT No.: PCT/KR2018/008162

§ 371 Date: Feb. 21, 2020

(30) Foreign Application Priority Data
Aug. 23, 2017 (KR) 10-2017-0106852

(51) Int. Cl. G06F 9/50; G06F 9/4401

(52) U.S. Cl. CPC G06F 9/5011; G06F 9/4406

(57) ABSTRACT

An electronic device includes a display, a communication circuit, a processor connected to the display and the communication circuit and including a plurality of cores, a volatile memory electrically connected to the processor, and a nonvolatile memory electrically connected to the processor, wherein the nonvolatile memory is configured to store at least one application program and store instructions that cause, when executed, the processor to execute a process of preloading shared classes and/or resources of an operating system for the at least one application program, and the executing of the process includes allocating a plurality of groups of the classes and/or the resources to two or more cores among the cores, and preloading the plurality of groups of the classes and/or the resources into the volatile memory in parallel using the two or more cores.

### CROSS-REFERENCE TO RELATED APPLICATIONS

This application is a 371 National Stage of International Application No. PCT/KR2018/008162, filed Jul. 19, 2018, which claims priority to Korean Patent Application No. 10-2017-0106852, filed Aug. 23, 2017, the disclosures of which are herein incorporated by reference in their entirety.

### BACKGROUND

### 1. Field

Embodiments disclosed herein relate to an operating technology of an operating system.

### 2. Description of Related Art

Recently, as the use of mobile electronic devices has rapidly increased, the demand for improving the performance of the electronic devices has increased. For example, a user of the electronic device expects to shorten a time until the electronic device is usable after the booting of the electronic device is completed when the user presses a power button of the electronic device.

Meanwhile, as electronic devices become more advanced, the performance of a processor is also improved. For example, the processor has been enhanced as not only a data processing speed is improved but also an ability to simultaneously execute a plurality of tasks (or processes) is improved. The processor has recently evolved from single core processors to multiple core processors. That is, in recent years, even in a method of performing parallel processing on an application program using threads, advance has been made from a thread processing of a single core processor in a time division multiplexing method to a method in which a plurality of cores of a multi-core processor process multiple threads in parallel.

### SUMMARY

In an electronic device employing the Android operating system, a zygote process may preload a Java class and resources to be used by a user process of an application program during booting. However, the zygote process preloads the Java class and the resources through a single thread and therefore, the Java class and the resources are preloaded sequentially. In addition, the probability of allocating the zygote process to a core through scheduling is inevitably reduced due to the execution of many processes during booting. As a result, a booting time may be longer under the existing Android operating systems.

Embodiments disclosed herein may provide a method of operating an operating system and an electronic device supporting the same, in which a Zygote process may preload Java classes and resources through multiple threads.

An electronic device according to an embodiment disclosed herein may include a display, a communication circuit, a processor connected to the display and the communication circuit and including a plurality of cores, a volatile memory electrically connected to the processor, and a nonvolatile memory electrically connected to the processor, wherein the nonvolatile memory may store at least one application program and store instructions that cause, when executed, the processor to execute a process of preloading shared classes and/or resources of an operating system for the at least one application program, and wherein the executing of the process may include allocating a plurality of groups of the classes and/or the resources to two or more cores among the cores, and preloading the plurality of groups of the classes and/or the resources into the volatile memory in parallel using the two or more cores.

Furthermore, an electronic device according to an embodiment disclosed herein may include a processor including a plurality of cores, a volatile memory electrically connected to the processor, and a nonvolatile memory electrically connected to the processor to store at least one application program, wherein the nonvolatile memory may store instructions that, when executed, cause the processor to execute a process of preloading at least one of classes and resources of the at least one application program into the nonvolatile memory, wherein the executing of the process may include generating a plurality of threads for the process, allocating the threads to two or more cores of the cores, and executing the threads in parallel using the two or more cores.

Furthermore, a method of operating an operating system of an electronic device including a processor including a plurality cores, according to an embodiment disclosed herein may include executing a process of preloading at least one of classes and resources of at least one application program stored in a nonvolatile memory into a volatile memory, wherein the executing of the process may include generating a plurality of threads for the process, allocating the threads to two or more cores of the cores, and executing the threads in parallel using the two or more cores.

According to the embodiments disclosed in the disclosure, the electronic device operates the zygote process using multiple threads to preload the Java classes and the resources in parallel or in serial, thereby reducing a time required for booting.

In addition, according to the embodiments disclosed in the disclosure, processes other than the zygote process are allocated only to limited cores to increase a probability that the zygote process is allocated to the core, thereby shortening the boot time.

In addition, various effects may be provided that are directly or indirectly understood through the disclosure.

### BRIEF DESCRIPTION OF THE DRAWINGS

FIG. 1 is a block diagram of an electronic device in a network environment, according to various embodiments.

FIG. 2 is a diagram for describing a configuration of an electronic device associated with operation of an operating system, according to an embodiment.

FIG. 3 is a diagram of a method of operating an electronic device related to operation of the operating system according to an embodiment.

FIG. 4 is a diagram for describing an allocation state of tasks for each core according to operation of an operating system, according to an embodiment.

FIG. 5 is a flowchart of a method of operating an operating system, according to an embodiment.

In the description of the drawings, the same or similar reference numerals may be used for the same or similar components.

### DETAILED DESCRIPTION

Prior to describing an embodiment of the disclosure, an electronic device to which an embodiment of the disclosure may be applied will be described.

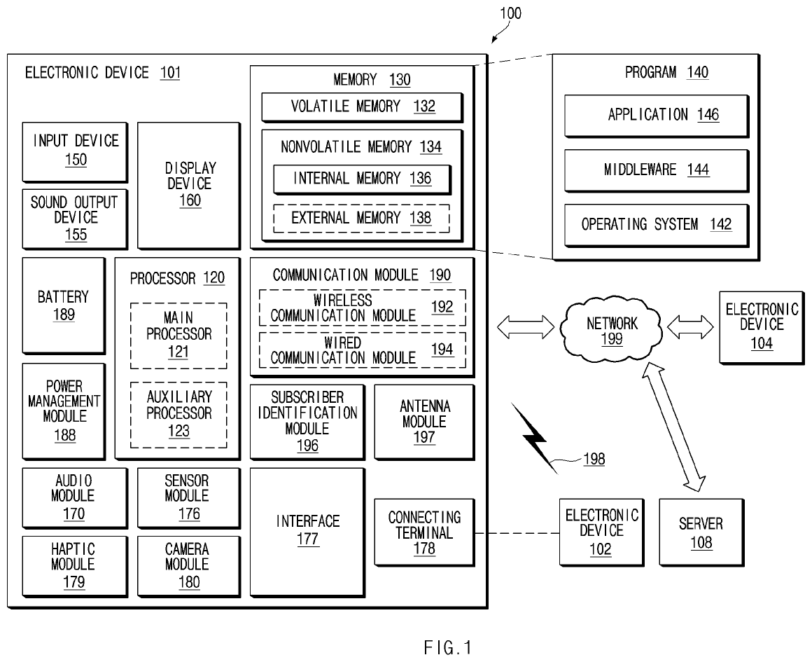

FIG. 1 is a block diagram of an electronic device in a network environment according to various embodiments.

Referring to FIG. 1, an electronic device 101 may communicate with an electronic device 102 through a first network 198 (e.g., a short-range wireless communication) or may communicate with an electronic device 104 or a server 108 through a second network 199 (e.g., a long-distance wireless communication) in a network environment 100. According to an embodiment, the electronic device 101 may communicate with the electronic device 104 through the server 108. According to an embodiment, the electronic device 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module 196, and an antenna module 197. According to some embodiments, at least one (e.g., the display device 160 or the camera module 180) among components of the electronic device 101 may be omitted or other components may be added to the electronic device 101. According to some embodiments, some components may be integrated and implemented as in the case of the sensor module 176 (e.g., a fingerprint sensor, an iris sensor, or an illuminance sensor) embedded in the display device 160 (e.g., a display).

The processor 120 may operate, for example, software (e.g., a program 140) to control at least one of other components (e.g., a hardware or software component) of the electronic device 101 connected to the processor 120 and may process and compute a variety of data. The processor 120 may load a command set or data, which is received from other components (e.g., the sensor module 176 or the communication module 190), into a volatile memory 132, may process the loaded command or data, and may store result data into a nonvolatile memory 134. According to an embodiment, the processor 120 may include a main processor 121 (e.g., a central processing unit or an application processor) and an auxiliary processor 123 (e.g., a graphic processing device, an image signal processor, a sensor hub processor, or a communication processor), which operates independently from the main processor 121, additionally or alternatively uses less power than the main processor 121, or is specified to a designated function. In this case, the auxiliary processor 123 may operate separately from the main processor 121 or embedded.

In this case, the auxiliary processor 123 may control, for example, at least some of functions or states associated with at least one component (e.g., the display device 160, the sensor module 176, or the communication module 190) among the components of the electronic device 101 instead of the main processor 121 while the main processor 121 is in an inactive (e.g., sleep) state or together with the main processor 121 while the main processor 121 is in an active (e.g., an application execution) state. According to an embodiment, the auxiliary processor 123 (e.g., the image signal processor or the communication processor) may be implemented as a part of another component (e.g., the camera module 180 or the communication module 190) that is functionally related to the auxiliary processor 123. The memory 130 may store a variety of data used by at least one component (e.g., the processor 120 or the sensor module 176) of the electronic device 101, for example, software (e.g., the program 140) and input data or output data with respect to commands associated with the software. The memory 130 may include the volatile memory 132 or the nonvolatile memory 134.

The program 140 may be stored in the memory 130 as software and may include, for example, an operating system 142, a middleware 144, or an application 146.

The input device 150 may be a device for receiving a command or data, which is used for a component (e.g., the processor 120) of the electronic device 101, from an outside (e.g., a user) of the electronic device 101 and may include, for example, a microphone, a mouse, or a keyboard.

The sound output device 155 may be a device for outputting a sound signal to the outside of the electronic device 101 and may include, for example, a speaker used for general purposes, such as multimedia play or recordings play, and a receiver used only for receiving calls. According to an embodiment, the receiver and the speaker may be either integrally or separately implemented.

The display device 160 may be a device for visually presenting information to the user of the electronic device 101 and may include, for example, a display, a hologram device, or a projector and a control circuit for controlling a corresponding device. According to an embodiment, the display device 160 may include a touch circuitry or a pressure sensor for measuring an intensity of pressure on the touch.

The audio module 170 may convert a sound and an electrical signal in dual directions. According to an embodiment, the audio module 170 may obtain the sound through the input device 150 or may output the sound through an external electronic device (e.g., the electronic device 102 (e.g., a speaker or a headphone)) wired or wirelessly connected to the sound output device 155 or the electronic device 101.

The sensor module 176 may generate an electrical signal or a data value corresponding to an operating state (e.g., power or temperature) inside or an environmental state outside the electronic device 101. The sensor module 176 may include, for example, a gesture sensor, a gyro sensor, a barometric pressure sensor, a magnetic sensor, an acceleration sensor, a grip sensor, a proximity sensor, a color sensor, an infrared sensor, a biometric sensor, a temperature sensor, a humidity sensor, or an illuminance sensor.

The interface 177 may support a designated protocol wired or wirelessly connected to the external electronic device (e.g., the electronic device 102). According to an embodiment, the interface 177 may include, for example, an HDMI (high-definition multimedia interface), a USB (universal serial bus) interface, an SD card interface, or an audio interface.

A connecting terminal 178 may include a connector that physically connects the electronic device 101 to the external electronic device (e.g., the electronic device 102), for example, an HDMI connector, a USB connector, an SD card connector, or an audio connector (e.g., a headphone connector).

The haptic module 179 may convert an electrical signal to a mechanical stimulation (e.g., vibration or movement) or an electrical stimulation perceived by the user through tactile or kinesthetic sensations. The haptic module 179 may include, for example, a motor, a piezoelectric element, or an electric stimulator.

The camera module 180 may shoot a still image or a video image. According to an embodiment, the camera module 180 may include, for example, at least one lens, an image sensor, an image signal processor, or a flash.

The power management module 188 may be a module for managing power supplied to the electronic device 101 and may serve as at least a part of a power management integrated circuit (PMIC).

The battery 189 may be a device for supplying power to at least one component of the electronic device 101 and may include, for example, a non-rechargeable (primary) battery, a rechargeable (secondary) battery, or a fuel cell.

The communication module 190 may establish a wired or wireless communication channel between the electronic device 101 and the external electronic device (e.g., the electronic device 102, the electronic device 104, or the server 108) and support communication execution through the established communication channel. The communication module 190 may include at least one communication processor operating independently from the processor 120 (e.g., the application processor) and supporting the wired communication or the wireless communication. According to an embodiment, the communication module 190 may include a wireless communication module 192 (e.g., a cellular communication module, a short-range wireless communication module, or a GNSS (global navigation satellite system) communication module) or a wired communication module 194 (e.g., an LAN (local area network) communication module or a power line communication module) and may communicate with the external electronic device using a corresponding communication module among them through the first network 198 (e.g., the short-range communication network such as a Bluetooth, a WiFi direct, or an IrDA (infrared data association)) or the second network 199 (e.g., the long-distance wireless communication network such as a cellular network, an interne, or a computer network (e.g., LAN or WAN)). The above-mentioned various communication modules 190 may be implemented into one chip or into separate chips, respectively.

According to an embodiment, the wireless communication module 192 may identify and authenticate the electronic device 101 using user information stored in the subscriber identification module 196 in the communication network.

The antenna module 197 may include one or more antennas to transmit or receive the signal or power to or from an external source. According to an embodiment, the communication module 190 (e.g., the wireless communication module 192) may transmit or receive the signal to or from the external electronic device through the antenna suitable for the communication method.

Some components among the components may be connected to each other through a communication method (e.g., a bus, a GPIO (general purpose input/output), an SPI (serial peripheral interface), or an MIPI (mobile industry processor interface)) used between peripheral devices to exchange signals (e.g., a command or data) with each other.

According to an embodiment, the command or data may be transmitted or received between the electronic device 101 and the external electronic device 104 through the server 108 connected to the second network 199. Each of the electronic devices 102 and 104 may be the same or different types as or from the electronic device 101. According to an embodiment, all or some of the operations performed by the electronic device 101 may be performed by another electronic device or a plurality of external electronic devices. When the electronic device 101 performs some functions or services automatically or by request, the electronic device 101 may request the external electronic device to perform at least some of the functions related to the functions or services, in addition to or instead of performing the functions or services by itself. The external electronic device receiving the request may carry out the requested function or the additional function and transmit the result to the electronic device 101. The electronic device 101 may provide the requested functions or services based on the received result as is or after additionally processing the received result. To this end, for example, a cloud computing, distributed computing, or client-server computing technology may be used.

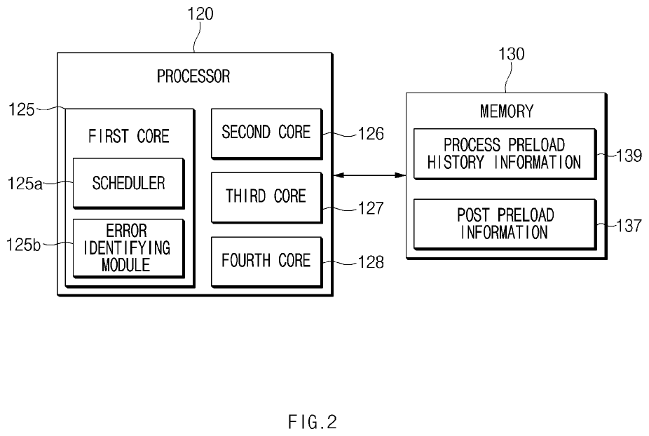

FIG. 2 is a diagram for describing a configuration of an electronic device associated with operation of an operating system, according to an embodiment.

Referring to FIG. 2, the processor 120 may include a plurality of cores. Although the processor 120 is illustrated as including a first core 125, a second core 126, a third core 127, and a fourth core 128 in the drawing, at least one of the aforementioned cores may be omitted, or the processor 120 may further include at least one other core.

The aforementioned cores (e.g., the first core 125, the second core 126, the third core 127, or the fourth core 128) may have the same performance or may have different performances. Here, the plurality of cores having different performances may refer to cores that operate at different clock frequencies.

In a multi-core environment, processes may be allocated to cores according to resources required for each process. For example, a process requiring a relatively large amount of resources and a process requiring a relatively small amount of resources are to be allocated according to the performance of the core or the process occupancy status of the core. Here, the process may mean a part of an application or the whole of the application. In addition, the performance of the core may mean ability to execute a process. That is, the core may have lower performance as more resources of a core are required to execute one same process and the core may have higher performance as fewer resources of a core are required to execute one same process.

At least one of the aforementioned cores may be a core that manages a process allocated to cores and a thread of the process. For example, as shown in the figure, the first core 125 may include a scheduler 125a that manages a process and threads allocated to another core (e.g., the second core 126, the third core 127, or the fourth core 128). The first core 125 may further include an error identifying module 125b that monitors threads of a process for each core.

According to an embodiment, the scheduler 125a may specify a core which is to execute a process according to, for example, the type of the process. For example, the scheduler 125a may perform setting such that a zygote process may be processed by all cores, and specify that a process of relatively low importance among processes other than the Zygote process may be processed only in limited cores. That is, the scheduler 125a may allow processes other than the zygote process to be allocated only to limited cores (e.g., CPU affinity setting) so that the zygote process may receive more scheduling.

According to one embodiment, the scheduler 125a may differently determine the number of threads for the process according to the processing performance of cores (e.g., the first core 125, the second core 126, the third core 127, or the fourth core 128). For example, when the cores have the same processing performance (e.g., in the case of symmetric multiprocessing (SMP)), the scheduler 125a may determine that the number of threads is half of the total number of cores. As another example, when the cores have different processing performance (e.g., in the case of heterogeneous multiprocessing), the scheduler 125a may determine that the number of threads corresponds to the number of high-performance cores (e.g., a big core).

According to one embodiment, the scheduler 125a may allocate threads of a process to cores. For example, the scheduler 125a may allocate threads of the process to cores specified to execute the process. In this case, the scheduler 125a may allocate threads to cores in consideration of the association (or dependency) of a function or routine to be processed through the thread.

According to one embodiment, when the process and the threads of the process have been scheduled by the scheduler 125a, the threads of the process allocated for each core may be performed. The threads performed for each core may be monitored by the error identifying module 125b. The error identifying module 125b may identify an execution time of each core and each thread, and when the execution time of the thread exceeds a specified time, record information about the thread (e.g., a function to be processed through the thread) in the memory 130. In addition, the error identifying module 125b may terminate the thread whose execution time exceeds the specified time and restart the corresponding process. In this case, the scheduler 125a may perform scheduling such that a function causing a problem (a function to be processed through a thread whose execution time exceeds the specified time) is to be processed after execution of other functions. In some embodiments, the scheduler 125a may allow the process to run as a single thread when the execution time of the thread exceeds the specified time.

According to one embodiment, when the execution of all processes is completed, the error identifying module 125b may store execution history information of the process in the memory 130. For example, the error identifying module 125b may store process preload history information 139 for the Java class and resources of the zygote process in connection with booting in the memory 130. The process preload history information 139 may be used by the scheduler 125a to schedule a process and the threads of the process at the time of the next booting. For example, the scheduler 125a may identify execution times for each core and each thread in the process preload history information 139, decrease the number of Java classes or resources to be preloaded with respect to a thread having a long execution time, and increase the number of Java classes or resources to preload with respect to a thread having a short execution time.

According to an embodiment, with respect to a thread whose execution time exceeds a specified time, the error identifying module 125b may store, in the memory 130, error information about Java classes or resources which have attempted to be preloaded through the thread. In this case, the scheduler 125a may identify the error information stored in the memory 130 at the time of the next booting, and allow the corresponding Java classes or resources to be preloaded after other Java classes and resources are preloaded (or before the preloading of other Java classes or resources is performed). The error information may be included in information (e.g., post preload information 137) on Java classes or resources that are to be preloaded, for example, after the preloading of other Java classes or resources is completed (or before the preloading of other Java classes or resources is performed).

According to an embodiment, the post preload information 137 may be predefined and stored in the memory 130. In addition, when firmware is updated through firmware over the air (FOTA), the post preload information 137 may be changed.

Hereinafter, a function of the processor 120 in an electronic device (e.g., the electronic device 101 of FIG. 1) to which the Android operating system is applied will be described.

In an electronic device to which the Android operating system is applied according to an embodiment of the disclosure, a zygote process may be started after an init process is started during a booting process. In other words, the zygote process may be initiated by the init process and may initialize a Dalvik virtual machine. Subsequently, various Java components in application framework may be executed under the control of the Dalvik virtual machine and system servers of the Java components may be Java components that are executed for the first time in the system.

Once the zygote process is initiated, the zygote process may preload Java classes and resources to be used by the user process of an application program. The zygote process may read out a list of Java classes to be preloaded from a specified file (e.g., /system/etc/preloaded-classes). The zygote process may also read out a list of resources to be preloaded. The zygote process may then preload Java classes and resources based on the list of Java classes and the list of resources, respectively.

According to an embodiment, the zygote process may preload Java classes and resources in parallel through multiple threads. The zygote process may preload Java classes through multiple threads, and when all the Java classes have been preloaded, preload resources through multiple threads. That is, the resources may be preloaded after all the Java classes have been preloaded. In this case, the scheduler 125a may allocate threads to cores.

According to an embodiment, when a plurality of zygote processes exist, the scheduler 125a may parallelize only zygote processes related directly to booting, that is, create multiple threads for the zygote processes related to booting, and allocate multiple threads to cores to allow the cores to execute the multiple threads.

According to an embodiment, the error identifying module 125b may terminate a thread and restart a corresponding zygote process when any one of the threads of the zygote process is executed for more than a specified time. In this case, the scheduler 125a may perform scheduling such that a function causing a problem, that is, a Java class and resources to be preloaded through a thread whose execution time exceeds the specified time are preloaded after other Java classes and resources are preloaded. In some embodiments, the scheduler 125a may execute the corresponding zygote process with a single thread.

According to an embodiment, the error identifying module 125b may store the process preload history information 139 of the zygote process in the memory 130 when all the zygote processes have been executed and the booting operation is completed. The process preload history information 139 may include, for example, execution time information of each thread of the zygote process and information on a Java class (or resources) preloaded through the thread.

According to an embodiment, when booting is started, the scheduler 125a may determine creation of multiple threads for the zygote process, allocation of the generated multi-threads for the zygote process, or the like, based on the process preload history information 139 stored in the memory 130.

As described above, according to various embodiments, an electronic device (e.g., the electronic device 101) may include a display (e.g., the display device 160), a communication circuit (e.g., the communication circuit 190), a processor (e.g., the processor 120) connected to the display and the communication circuit and including a plurality of cores, a volatile memory (e.g., the volatile memory 132) electrically connected to the processor, a nonvolatile memory (e.g., the nonvolatile memory 134) electrically connected to the processor, wherein the nonvolatile memory may store at least one application program and store instructions that cause, when executed, the processor to execute a process of preloading shared classes and/or resources of an operating system for the at least one application program, and wherein the executing of the process may include allocating a plurality of groups of the classes and/or the resources to two or more cores among the cores; and preloading the plurality of groups of the classes and/or the resources into the volatile memory in parallel using the two or more cores.

According to various embodiments, the executing of the process may further include preloading the plurality of groups of the classes and/or the resources sequentially when the preloading of the plurality of groups of the classes and/or the resources is not completed within a selected time range, or when an error occurs.

According to various embodiments, the operating system may be an Android operating system, and the process may be a Zygote process.

According to various embodiments, the allocating of the plurality of groups of the classes and/or the resources may further include providing a plurality of lists of the classes and/or the resources for preloading.

According to various embodiments, the executing of the process may further include selecting the two or more cores before the allocating of the plurality of groups.

According to various embodiments, the allocating of the plurality of groups of the classes and/or the resources may include grouping the classes and/or the resources at least partially based on sizes and dependencies of the classes and/or the resources.

According to various embodiments, the Zygote process may include a Zygote main method including a preload method, and the preload method may include allocating the plurality of groups of the classes and/or the resources to two or more cores, and preloading the plurality of groups of the classes and/or the resources into the nonvolatile memory in parallel using the two or more cores.

According to various embodiments, an electronic device (e.g., the electronic device 101) may include a processor (e.g., the processor 120) including a plurality of cores, a volatile memory (e.g., the volatile memory 132) electrically connected to the processor, a nonvolatile memory (e.g., the nonvolatile memory 134) electrically connected to the processor to store at least one application program, wherein the nonvolatile memory may store instructions that, when executed, cause the processor to execute a process of preloading at least one of classes and resources of the at least one application program into the nonvolatile memory, and wherein the executing of the process may include generating a plurality of threads for the process, allocating the threads to two or more cores of the cores, and executing the threads in parallel using the two or more cores.

According to various embodiments, the generating of the threads may further include determining a number of the threads based on at least one of a number of the cores and performance of the cores.

According to various embodiments, the generating of the threads may include generating the threads based on at least one of sizes of the classes and the resources and dependency relationships between the classes and the resources.

According to various embodiments, the executing of the process may further include re-executing the process when an execution time of one of the threads exceeds a specified time, and the re-executing of the process may include executing the process through one thread in a sequential manner.

According to various embodiments, the executing of the process may further include storing information on at least one of the classes and the resources to be preloaded through the thread in the nonvolatile memory when an execution time of one of the threads exceeds the specified time.

According to various embodiments, the executing of the process may further include determining whether to execute the process in a sequential manner or in a parallel manner based on information on at least one of the classes and the resources stored in the nonvolatile memory.

According to various embodiments, the nonvolatile memory may further store instructions that, when executed, cause the processor to execute another process other than the process, and the executing of the another process may include executing the another process using at least one another core other than the specified at least one core of the cores.

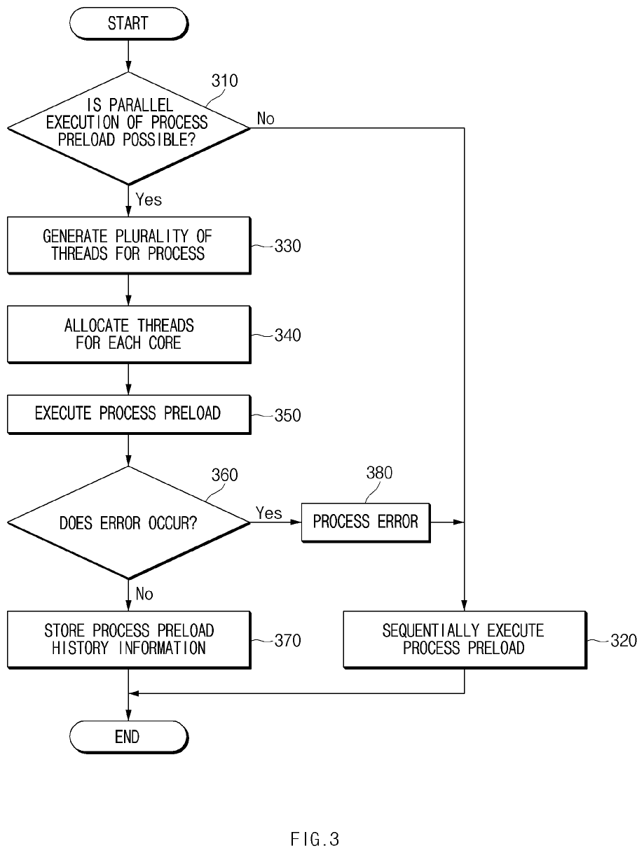

FIG. 3 is a diagram of a method of operating an electronic device related to operation of the operating system according to an embodiment.

Referring to FIG. 3, in operation 310, the processor 120 of the electronic device 101 may determine whether a preload function of a process is executable in parallel at the time of booting. For example, the scheduler 125a of the processor 120 may determine whether the preloading of the Java class and resources of a zygote process is executable in parallel. According to an embodiment, the scheduler 125a may determine whether there is error information occurring at the time of previous booting based on the process preload history information 139 stored in the memory 130. The scheduler 125a may determine that the preload function of the Zygote process is not executable in a parallel manner when there is error information occurring during previous booting. When the preload function of the zygote process is not executable in a parallel manner due to an error occurring during donation, in operation 320, the scheduler 125a may execute the preload function of the zygote process in a sequential manner. For example, the scheduler 125a may execute the Zygote process in a single thread. A case where the preload function of the zygote process is not executable in a parallel manner may include, for example, a case where a new Java class is updated through firmware over the air (FOTA), or a case where an integrity problem related to firmware is caused due to modification by a user or external hacking operation, and the like.

According to one embodiment, when the preload function of the zygote process is executable in a parallel manner, in operation 330, the scheduler 125a may generate e a plurality of threads for the zygote process. According to one embodiment, the scheduler 125a may differently determine the number of threads for the zygote process according to the processing performance of cores (e.g., the first core 125, the second core 126, the third core 127, or the fourth core 128). As an example, the scheduler 125a may determine the number of threads to correspond to half of the total number of cores when the cores have the same processing performance, and the number of threads to correspond to the number of high performance cores when the cores have different processing performance. In addition, the scheduler 125a may identify an execution time of each thread of the zygote process and data (e.g., Java class or resources) preloaded through each thread based on the process preload history information 139 and determine the number of Java classes or resources to be preloaded through the thread based on the execution time of each thread. For example, the scheduler 125a may decrease the number of Java classes or resources to be preloaded for a thread that have taken the longest execution time within a specified time, which may be determined as a thread execution error, and increase the number of Java classes or resources to be preloaded for a thread that have taken the shortest execution time. That is, the scheduler 125a may redistribute the classes or resources allocated to the threads and reflect the redistribution at the time of the next booting, for a thread of which the execution time is within the specified time (the reference time for determination as the execution error of the thread).

In operation 340, the scheduler 125a may allocate a thread for each core. As an example, the scheduler 125a may allocate threads of the zygote process to all cores. As another example, the scheduler 125a may allocate processes other than the zygote process only to limited cores.

According to an embodiment, the scheduler 125a may allow Java classes or resources that are to be preload through a thread that caused the error at the time of a previous booting (e.g., a thread whose execution time exceeds a specified time) to be preloaded after other Java classes or resources have been preloaded. For example, the scheduler 125a may specify an order such that a thread for preloading the corresponding Java class or resources are allocated to a core after a thread for preloading other Java classes or resources has been executed.

According to an embodiment, the scheduler 125a may allocate threads to cores in consideration of an association (or dependency) of a Java class or resources to be preloaded through a thread of the zygote process. For example, the scheduler 125a may specify an order of a thread such that a thread for preloading a Java class is executed preferentially over a thread for preloading resources. As another example, the scheduler 125a may allocate threads for preloading a Java class or resources with dependencies to a single core. As another example, the scheduler 125a may execute threads for preloading a Java class or resources with dependencies after the thread for preloading a Java class or resources with no dependencies. The dependency of the Java class or resources may be identified through a test, for example. According to an embodiment, the scheduler 125a may allocate threads to cores in consideration of a size (or data amount) of a Java class or resources to be preloaded through a thread of the zygote process. For example, the scheduler 125a may allocate a thread for preloading a Java class or resources having a relatively large size (or data amount) to a relatively high performance core. As another example, the scheduler 125a may group Java classes or resources in units of a predetermined size, and allocate a thread for preloading Java classes or resources to each core in units of groups.

According to an embodiment, the memory 130 may store information about Java classes or resources that are to be preloaded after another Java class has been preloaded, for example, post preload information 137. For example, the memory 130 may store information on association (or dependency) for Java classes or resources. In this case, the scheduler 125a may receive information on the association (or dependency) of the Java classes (e.g., post preload information 137) from the memory 130 and specify preload orders of the Java classes. In some embodiments, memory 130 may only store a list of Java classes that are to be preloaded preferentially. In this case, the scheduler 125a may preferentially allocate the Java classes which are to be preloaded preferentially to cores using multiple threads.

In operation 350, each core of the processor 120 (e.g., the first core 125, the second core 126, the third core 127, or the fourth core 128) may execute the allocated threads. The threads performed for each core may be monitored by the error identifying module 125b.

In operation 360, the error identifying module 125b may determine whether an error occurs during the execution of each thread. According to an embodiment, the error identifying module 125b may identify execution times for each core and each thread, and determine that an execution error of a thread occurs when the execution time of the thread exceeds a specified time. According to an embodiment, with respect to a thread in which an execution error has occurred, the error identifying module 125b may store, in the memory 130, information on Java classes or resources that are to be preloaded through the thread. In this case, the scheduler 125a may identify the information on the Java classes or resources stored in the memory 130 at the time of the next booting, and store and manage the information in the post preload information 137 such that the Java classes or resources are preloaded after the other Java classes or resources have been preloaded.

In operation 370, when the threads of all the Zygote processes have been executed without causing execution error of the threads, the error identifying module 125b may store execution history information of the threads (e.g., process preload history information 139) in the memory 130. For example, the error identifying module 125b may store, in the memory 130, information on an execution time of each thread and information on a Java class (or resources) preloaded through each thread.

When an execution error of a thread occurs, in operation 380, the error identifying module 125b may perform error processing. According to an embodiment, the error identifying module 125b may terminate a thread in which an error occurs. According to another embodiment, the error identifying module 125b may store information on the thread in which an error occurs, for example, information on a Java class (or resources) to be preloaded through the thread in the memory 130.

When the error processing is completed, in operation 320, the scheduler 125a may execute the preload function of the zygote process in a sequential manner. For example, the scheduler 125a may execute the Zygote process in a single thread.

The above-described preload operation of the zygote process may be implemented through a preload method (e.g., preload ( )). Table 1 below shows some of the main methods of the zygote process (e.g., main ( )).

TABLE 1
public static void main(String argv[ ]){
try{
SamplingProfilerIntegration.start( );
registerZygoteSocket( );
EventLog.writeEvent(LOG_BOOT_PROGRESS_PRELOAD_START,
SystemClock.uptimeMillis( ));
preload( );
EventLog.writeEvent(LOG_BOOT_PROGRESS_PRELOAD_END,
SystemClock.uptimeMillis( ));
SamplingProfilerIntegration.writeZygoteSnapshot( );
...
}
}

According to an embodiment, the preload method may include grouping Java classes and resources into a plurality of groups and allocating the groups of Java classes and the resources to the cores. In addition, the preload method may include an operation of preloading the groups in parallel using the cores.

As described above, according to various embodiments, a method of operating an operating system of an electronic device (e.g., the electronic device 101) including a processor (e.g., the processor 120) including a plurality cores includes executing a process of preloading at least one of classes and resources of at least one application program stored in a nonvolatile memory into a volatile memory, wherein the executing of the process includes generating a plurality of threads for the process; allocating the threads to two or more cores of the cores; and executing the threads in parallel using the two or more cores.

According to various embodiments, the generating of the threads may further include determining a number of the threads based on at least one of a number of the cores and performance of the cores.

According to various embodiments, the generating of the threads may include generating the threads based on at least one of sizes of the classes and the resources and dependency relationships between the classes and the resources.

According to various embodiments, the executing of the process may further include re-executing the process when an execution time of one of the threads exceeds a specified time, and the re-executing of the process may include executing the process through one thread in a sequential manner.

According to various embodiments, the executing of the process may further include storing information on at least one of the classes and the resources to be preloaded through the thread in the nonvolatile memory when an execution time of one of the threads exceeds the specified time and the executing of the process may include determining whether to execute the process in a sequential manner or in a parallel manner based on the information on the at least one of the classes and the resources stored in the nonvolatile memory.

According to various embodiments, the method of operating the operating system may further include executing another process other than the process and the executing of the other process may include executing the other process using at least one another core other than the specified at least one core of the cores.

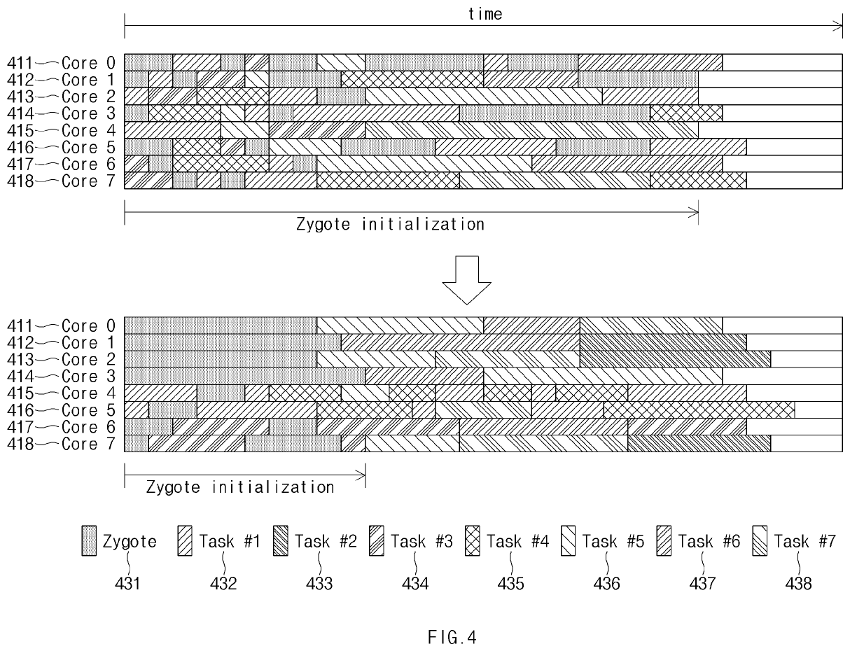

FIG. 4 is a diagram for describing an allocation state of tasks for each core according to operation of an operating system, according to an embodiment.

Referring to FIG. 4, the processor 120 of the electronic device 101 may include a plurality of cores (e.g., a first core 411, a second core 412, a third core 413, and a fourth core 414, a fifth core 415, a sixth core 416, a seventh core 417, or an eighth core 418).

Referring to FIG. 4, it can be seen that the booting time can be shortened when a core to execute a process is limited. For example, the upper graph of FIG. 4 shows an allocation state of tasks (or processes) for each core when a core to execute a process is not defined and the lower graph of FIG. 4 shows an allocation state of tasks (or processes) for each core when a core (e.g., a low-performance core (or a little core)) to execute processes other than a zygote process 431 is defined.

It can be seen from the lower graph of FIG. 4 that the zygote process 431 is executed in all cores, while other processes (e.g., a first process 432, a second process 433, a third process 434, a fourth process 435, a fifth process 436, a sixth process 437, and a seventh process 438) are executed only in a limited core.

As shown in FIG. 4, in the case of limiting a core to execute the processes other than the Zygote process 431, the execution time of the Zygote process 431 may be shortened, resulting in shortening of the booting time.

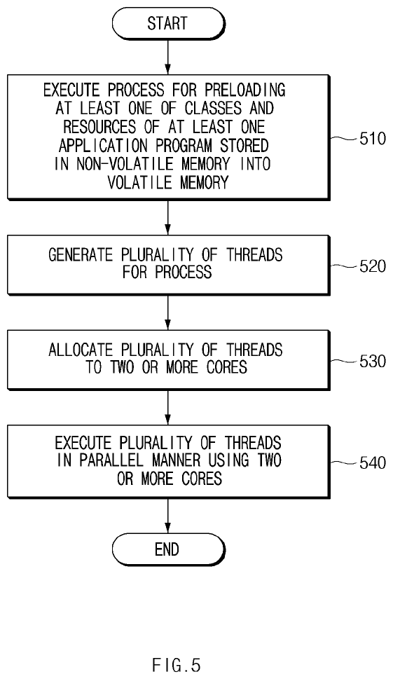

FIG. 5 is a flowchart of a method of operating an operating system, according to an embodiment.

Referring to FIG. 5, in operation 510, a processor (e.g., processor 120 of FIG. 1) may execute a process for preloading at least one of classes and resources of at least one application program stored in a nonvolatile memory (e.g., the nonvolatile memory 134 of FIG. 1), into a volatile memory (e.g., the volatile memory 132 of FIG. 1). The process may be, for example, a zygote process.

In operation 520, the processor 120 may generate a plurality of threads for the executed process.

In operation 530, the processor 120 may allocate a plurality of threads to two or more cores.

In operation 540, the processor 120 may execute a plurality of threads in parallel using two or more cores.

The electronic device according to various embodiments disclosed in the present disclosure may be various types of devices. The electronic device may include, for example, at least one of a portable communication device (e.g., a smartphone), a computer device, a portable multimedia device, a mobile medical appliance, a camera, a wearable device, or a home appliance. The electronic device according to an embodiment of the present disclosure should not be limited to the above-mentioned devices.

It should be understood that various embodiments of the present disclosure and terms used in the embodiments do not intend to limit technologies disclosed in the present disclosure to the particular forms disclosed herein; rather, the present disclosure should be construed to cover various modifications, equivalents, and/or alternatives of embodiments of the present disclosure. With regard to description of drawings, similar components may be assigned with similar reference numerals. As used herein, singular forms may include plural forms as well unless the context clearly indicates otherwise. In the present disclosure disclosed herein, the expressions “A or B”, “at least one of A or/and B”, “A, B, or C” or “one or more of A, B, or/and C”, and the like used herein may include any and all combinations of one or more of the associated listed items. The expressions “a first”, “a second”, “the first”, or “the second”, used in herein, may refer to various components regardless of the order and/or the importance, but do not limit the corresponding components. The above expressions are used merely for the purpose of distinguishing a component from the other components. It should be understood that when a component (e.g., a first component) is referred to as being (operatively or communicatively) “connected,” or “coupled,” to another component (e.g., a second component), it may be directly connected or coupled directly to the other component or any other component (e.g., a third component) may be interposed between them.

The term “module” used herein may represent, for example, a unit including one or more combinations of hardware, software and firmware. The term “module” may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, the “module” may include an application-specific integrated circuit (ASIC).

Various embodiments of the present disclosure may be implemented by software (e.g., the program 140) including an instruction stored in a machine-readable storage media (e.g., an internal memory 136 or an external memory 138) readable by a machine (e.g., a computer). The machine may be a device that calls the instruction from the machine-readable storage media and operates depending on the called instruction and may include the electronic device (e.g., the electronic device 101). When the instruction is executed by the processor (e.g., the processor 120), the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

According to an embodiment, the method according to various embodiments disclosed in the present disclosure may be provided as a part of a computer program product. The computer program product may be traded between a seller and a buyer as a product. The computer program product may be distributed in the form of machine-readable storage medium (e.g., a compact disc read only memory (CD-ROM)) or may be distributed only through an application store (e.g., a Play Store™). In the case of online distribution, at least a portion of the computer program product may be temporarily stored or generated in a storage medium such as a memory of a manufacturer's server, an application store's server, or a relay server.

Each component (e.g., the module or the program) according to various embodiments may include at least one of the above components, and a portion of the above sub-components may be omitted, or additional other sub-components may be further included.

Alternatively or additionally, some components (e.g., the module or the program) may be integrated in one component and may perform the same or similar functions performed by each corresponding components prior to the integration. Operations performed by a module, a programming, or other components according to various embodiments of the present disclosure may be executed sequentially, in parallel, repeatedly, or in a heuristic method. Also, at least some operations may be executed in different sequences, omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. An electronic device comprising:
a display;
a communication circuit;
a processor connected to the display and the communication circuit and including a plurality of cores;
a volatile memory electrically connected to the processor; and
a nonvolatile memory electrically connected to the processor,
wherein the nonvolatile memory is configured to store at least one application program and store instructions that cause, when executed, the processor to execute a process of preloading shared classes and/or resources of an operating system for the at least one application program,
wherein the executing of the process includes
allocating a plurality of groups of the classes and/or the resources to two or more cores among the cores; and
preloading the plurality of groups of the classes and/or the resources into the volatile memory in parallel using the two or more cores.

2. The electronic device of claim 1, wherein the executing of the process further includes
preloading the plurality of groups of the classes and/or the resources sequentially when the preloading of the plurality of groups of the classes and/or the resources is not completed within a selected time range, or when an error occurs.

3. The electronic device of claim 1, wherein the operating system is an Android operating system, and
wherein the process is a Zygote process.

4. The electronic device of claim 1, wherein the allocating of the plurality of groups of the classes and/or the resources further includes providing a plurality of lists of the classes and/or the resources for preloading.

5. The electronic device of claim 4, wherein the executing of the process further includes selecting the two or more cores before the allocating of the plurality of groups.

6. The electronic device of claim 4, wherein the allocating of the plurality of groups of the classes and/or the resources includes grouping the classes and/or the resources at least partially based on sizes and dependencies of the classes and/or the resources.

7. The electronic device of claim 3, wherein the Zygote process includes a Zygote main method including a preload method,
wherein the preload method includes
allocating the plurality of groups of the classes and/or the resources to the two or more cores; and
preloading the plurality of groups of the classes and/or the resources into the volatile memory in parallel using the two or more cores.

8. An electronic device comprising:
a processor including a plurality of cores;
a volatile memory electrically connected to the processor;
a nonvolatile memory electrically connected to the processor and storing at least one application program,
wherein the nonvolatile memory stores instructions that, when executed, cause the processor to execute a process of preloading at least one of classes and resources of the at least one application program into the nonvolatile memory,
wherein the executing of the process includes
generating a plurality of threads for the process;
allocating the threads to two or more cores of the cores; and
executing the threads in parallel using the two or more cores.

9. The electronic device of claim 8, wherein the generating of the threads further includes determining a number of the threads based on at least one of a number of the cores and performance of the cores.

10. The electronic device of claim 8, wherein the generating of the threads includes generating the threads based on at least one of sizes of the classes and the resources, and dependency relationships between the classes and the resources.

11. The electronic device of claim 8, wherein the executing of the process further includes re-executing the process when an execution time of one of the threads exceeds a specified time, and wherein the re-executing of the process includes executing the process through one thread in a sequential manner.

12. The electronic device of claim 11, wherein the executing of the process further includes storing information on at least one of the classes and the resources to be preloaded through the thread in the nonvolatile memory when an execution time of one of the threads exceeds the specified time.

13. The electronic device of claim 12, wherein the executing of the process further includes determining whether to execute the process in a sequential manner or in a parallel manner based on the information on the at least one of the classes and the resources stored in the nonvolatile memory.

14. The electronic device of claim 8, wherein the nonvolatile memory further stores instructions that, when executed, cause the processor to execute another process other than the process,
wherein the executing of the another process includes executing the another process using at least one another core other than the specified at least one core among the cores.

15. A method of operating an operating system of an electronic device including a processor including a plurality cores, the method comprising:
executing a process of preloading at least one of classes and resources of at least one application program stored in a nonvolatile memory into a volatile memory,
wherein the executing of the process includes
generating a plurality of threads for the process;
allocating the threads to two or more cores of the cores; and
executing the threads in parallel using the two or more cores.
